(19) United States
(12) Patent Application Publication
(10) Pub. No.: US 2021/0350142 A1
(43) Pub. Date: Nov. 11, 2021

(54) IN-TRAIN POSITIONING AND INDOOR POSITIONING

(71) Applicant: Beijing Sankuai Online Technology Co., Ltd., Beijing (CN)

(72) Inventor: Qiong NIE, Beijing (CN)

(21) Appl. No.: 17/276,823

(22) PCT Filed: Sep. 16, 2019
(86) PCT No.: PCT/CN2019/105969

§ 371 Date: Mar. 17, 2021

(30) Foreign Application Priority Data
Sep. 17, 2018 (CN) 201811082493.2

(51) Int. Cl. G06K 9/00; G06K 9/62; G06T 7/73; G06T 7/246; G06T 7/50; H04W 4/029; H04W 4/021

(52) U.S. Cl. CPC G06K 9/00771; G06K 9/6215; G06K 9/6202; G06T 7/73; G06T 2207/30232; G06T 7/50; H04W 4/029; H04W 4/021; G06T 7/246

(57) ABSTRACT

This application relates to an in-train localization method, including: obtaining an environment image in a train; determining feature objects based on the environment image, wherein the feature objects are arranged in the train according to a preset rule; and determining a position of a mobile device in the train based on a number of feature objects by which the mobile device has passed.

### CROSS REFERENCE TO RELATED APPLICATIONS

This application is a national phase entry under 35 USC 371 of International Patent Application No. PCT/CN2019/105969, filed on Sep. 16, 2019, which claims priority to Chinese Patent Application No. 2018110824932, titled “IN-TRAIN LOCALIZATION METHOD AND DEVICE”, filed on Sep. 17, 2018, the contents of all of which are incorporated herein by reference.

### TECHNICAL FIELD

This application relates to the field of localization technologies, and in particular, to solutions to in-train localization and in-room localization.

### BACKGROUND

In-train localization using a GPS has a very poor effect because carriages are located in a room. Therefore, in related art, the localization is mainly performed through a simultaneous localization and mapping (SLAM) technology.

However, the SLAM technology not only requires configuration of a lidar scanning environment, which is costly, but also requires construction of an environment map according to scanning results. For the constructed map, image optimization such as filtering is required. The processing is relatively complicated and time-consuming, and therefore a real-time localization effect is relatively poor.

### SUMMARY

According to a first aspect of embodiments of this application, an in-train localization method is provided, including:

obtaining environment images in a train;

determining feature objects based on the environment images, where the feature objects are arranged in the train according to a preset rule; and

determining a position of a mobile device in the train based on a number of feature objects by which the mobile device has passed.

According to a second aspect of the embodiments of this application, a mobile device is provided, including:

a processor; and

a memory configured to store instructions executable by the processor; where

the processor is configured to perform the above in-train localization method.

According to a third aspect of the embodiments of this application, a computer readable medium is provided, having stored thereon a computer program which, when executed by a processor, performs the above in-train localization method.

According to a fourth aspect of embodiments of this application, an in-room localization method is provided, including: obtaining environment images in a room; determining feature objects based on the environment images, where the feature objects are arranged in the room according to a preset rule; and determining a position of a mobile device in the room based on a number of feature objects by which the mobile device has passed.

According to a fifth aspect of the embodiments of this application, a mobile device is provided, including: a processor; and a memory configured to store a processor executable instruction, where the processor is configured to perform the above in-room localization method.

According to a sixth aspect of the embodiments of this application, a computer readable storage medium is provided, having stored thereon a computer program which, when executed by a processor, performs the above in-room localization method.

According to the embodiments of this application, a position of a robot in a room may be determined according to a number of feature objects by which the robot has passed, and the feature objects are extracted from the environment image. On the one hand, there is no need to construct a map through SLAM, and therefore there is no need to dispose a lidar on the robot, so that costs can be reduced. On the other hand, only the number of feature objects by which the robot has passed needs to be determined, which has a simple calculation process and is less time-consuming compared to determining coordinates of the robot in the map, so that real-time localization can be guaranteed.

It should be understood that the above general descriptions and the following detailed descriptions are merely for exemplary and explanatory purposes, and cannot limit this application.

### BRIEF DESCRIPTION OF THE DRAWINGS

Accompanying drawings herein are incorporated into the specification and constitute a part of this specification, show embodiments that conform to this application, and are used for describing a principle of this application together with this specification.

FIG. 1A is a schematic flowchart of an in-room localization method according to an embodiment of this application.

FIG. 1B is a schematic flowchart of an in-train localization method according to an embodiment of this application.

FIG. 2 is a schematic flowchart of determining a position of a mobile device in a train based on a number of feature objects by which the mobile device has passed according to an embodiment of this application.

FIG. 3 is a schematic flowchart of another in-train localization method according to an embodiment of this application.

FIG. 4 is a schematic flowchart of determining a number of feature objects by which a mobile device has passed according to an embodiment of this application.

FIG. 5 is a schematic flowchart of tracking a feature object according to a preset manner according to an embodiment of this application.

FIG. 6 is a schematic flowchart of updating a position of a feature object in an environment image according to an embodiment of this application.

FIG. 7 is a schematic flowchart of determining whether tracking of a feature object is ended according to an embodiment of this application.

FIG. 8 is a schematic flowchart of another method of determining whether tracking of a feature object is ended according to an embodiment of this application.

FIG. 9 is a hardware structure diagram of a robot where an in-train localization apparatus is located according to an embodiment of this application.

FIG. 10 is a schematic block diagram of an in-train localization apparatus according to an embodiment of this application.

FIG. 11 is a schematic block diagram of a position determining unit according to an embodiment of this application.

FIG. 12 is a schematic block diagram of another in-train localization apparatus according to an embodiment of this application.

FIG. 13 is a schematic block diagram of another position determining unit according to an embodiment of this application.

FIG. 14 is a schematic block diagram of a tracking subunit according to an embodiment of this application.

FIG. 15 is a schematic block diagram of a position updating module according to an embodiment of this application.

### DETAILED DESCRIPTION OF THE EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of devices and methods that are described in detail in the appended claims and that are consistent with some aspects of this application.

The terms used in this application are for the purpose of describing specific embodiments only and are not intended to limit this application. The singular forms of “a” and “the” used in this application and the appended claims are intended to include the plural forms as well, unless the context clearly indicates otherwise. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Depending on the context, for example, the word “if” used herein may be interpreted as “while” or “when,” or “in response to determination.”

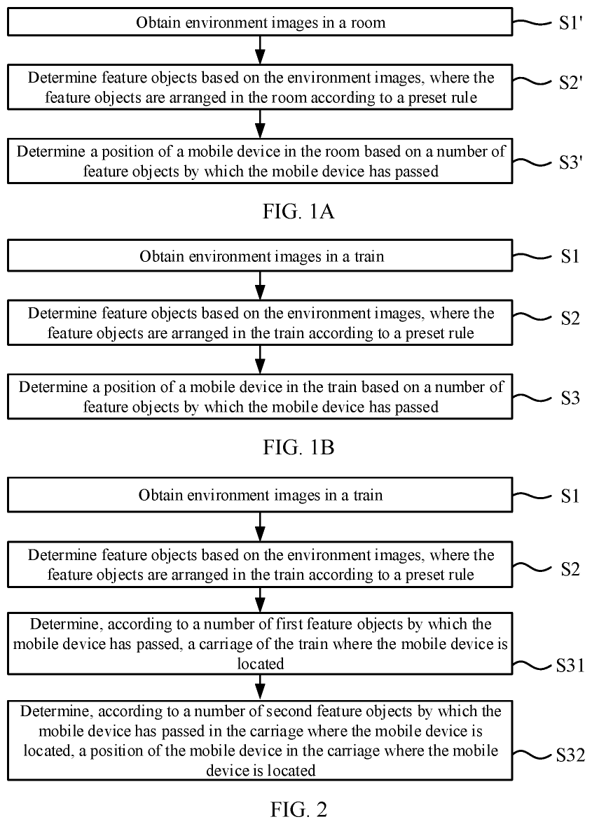

FIG. 1A is a schematic flowchart of an in-room localization method according to an embodiment of this application. The method shown in this embodiment may be applied to a mobile device, such as a robot. The robot can move in a specific region, for example, in a train.

The in-room localization method in this embodiment of this application includes the following steps.

Step S1′: Obtain environment images in a room.

Step S2′: Determine feature objects based on the environment images, where the feature objects are arranged in the room according to a preset rule.

Step S3′: Determine a position of a mobile device in the room based on a number of feature objects by which the mobile device has passed.

The technical solutions of the present disclosure are described below by exemplifying a robot moving in a train. The robot can perform tasks such as delivery (for example, a cargo loading apparatus is equipped on the robot), ticket inspection (for example, a scanning apparatus is equipped on the robot), and cleaning (for example, a cleaning apparatus is equipped on the robot).

As shown in FIG. 1B, the in-train localization method may include the following steps S1 to S3.

Step S1: Obtain environment images in a train.

In an embodiment, an image collecting device such as a depth camera may be disposed on the robot. In this case, the collected environment image may be a depth image. Certainly, other image collecting devices may also be selected as required to obtain environment images.

In an embodiment, the train refers to a vehicle having a plurality of carriages, for example, a fast passenger train, a subway, a G-series high-speed train, or a D-series high-speed train.

Step S2: Determine feature objects based on the environment images. The feature objects may be arranged in the train according to a preset rule.

In an embodiment, the preset rule based on which the feature objects are arranged in the train may include one or a combination of a plurality of rules as follows: a number of feature objects is positively correlated with a number of carriages of the train, the feature objects are arranged in a preset order in the train, and the feature objects are arranged at an equal interval in the train.

In an embodiment, a bounding box of the collected environment image may be obtained. The bounding box may be understood as a rectangular box surrounding an object in the image. The obtained bounding box may be processed according to the MASK-RCNN (an object detection algorithm performed through a convolutional neural network) or the SSD (an object detection algorithm that directly predicts coordinates and a category of the bounding box) to determine whether the bounding box is a feature object. In addition to the above two methods, an identification model may also be trained through machine learning, and the feature objects may be identified from the environment image according to the identification model. A specific process of determining the feature objects is not a main improvement of this embodiment, and therefore details are not described herein again.

Step S3: Determine a position of a mobile device in the train based on a number of feature objects by which the mobile device has passed.

In an embodiment, the feature objects may be a carriage door, a window, a seat (which may be an integral seat or a partial structure of a seat, such as a handle and a backrest of the seat), a sleeper, and the like. For example, each carriage is provided with one carriage door at both ends, and the arrangement according to the preset rule may mean that a ratio of a number of carriage doors to a number of carriages is 2, and that the carriage doors are arranged in the train in a length direction of the carriages. For another example, each carriage is provided with K (K is a positive integer) row of seats, and the arrangement according to the preset rule may mean that a ratio of a number of seats to the number of carriages is a product of K and a number of seats in each row and that the seats are arranged in the train in the length direction of the carriages.

Since the feature objects are arranged in the train according to the preset rule, when the robot moves in the train in a manner related to the preset rule, a larger number of feature objects by which the robot has passed indicates a longer distance by which the robot travels. Therefore, a position of the robot in the train may be determined according to the distances and the preset rule.

For example, the arrangement according to the preset rule means that the number of feature objects is positively correlated with the number of carriages and that the feature objects are arranged in the train in the length direction of the carriages. In this case, when the robot moves in the length direction of the carriages, the distance by which the robot travels is positively related to the number of feature objects by which the robot has passed. Therefore, the position of the robot in the train may be determined according to the number of feature objects by which the robot has passed.

A start position and a direction of movement of the robot may be first determined. For example, the seat serves as a feature object, the start position of the robot is a head of the train, the robot moves toward a tail of the train, the carriages from the head to the tail are carriages 1 to 8, each of the carriages includes 20 rows of seats which are seats of row 1 to row 20 assembled from the head to the tail. If the robot has passed by 65 feature objects, it may be determined that the robot has passed by 3 carriages and is currently located in carriage 4, and the robot has passed by 5 rows of seats in carriage 4 and is currently located in a seat at row 6, so that it may be determined that the position of the robot in the train is a seat at row 6 in carriage 4.

According to the embodiment of this application, the position of the robot in the train may be determined according to a number of feature objects by which the robot has passed, and the feature objects are extracted from the environment image. On the one hand, there is no need to construct a map through SLAM, and therefore there is no need to dispose a lidar on the robot, so that costs can be reduced. On the other hand, only the number of feature objects by which the robot has passed needs to be determined, which has a simple calculation process and is less time-consuming compared to determining coordinates of the robot in the map, so that real-time localization can be guaranteed.

It should be noted that the concept of this embodiment may also be applied to other spatial scenes, such as a movie theater, a workshop, a warehouse, and the like. For example, when the concept is applied to a movie theater, the feature object may be a seat, and the position of the mobile device in the movie theater may be determined according to a number of seats by which the mobile device has passed. For another example, when the concept is applied to a workshop, the position of the mobile device in the workshop may be determined according to a number of machine tools by which the mobile device has passed. For another example, when the concept is applied to a warehouse, the position of the mobile device in the warehouse may be determined according to a number of storage items (such as boxes, barrels) by which the mobile device has passed.

FIG. 2 is a schematic flowchart of determining a position of a mobile device in a train based on a number of feature objects by which the mobile device has passed according to an embodiment of this application. As shown in FIG. 2, based on the embodiment shown in FIG. 1, the feature objects include first feature objects and second feature objects, and the determining a position of a mobile device in the train based on a number of feature objects by which the mobile device has passed includes the following steps.

Step S31: Determine, based on a number of first feature objects by which the mobile device has passed, a carriage of the train where the mobile device is located.

Step S32: Determine, according to a number of second feature objects by which the mobile device has passed in the carriage where the mobile device is located, a position of the mobile device in the carriage where the mobile device is located.

In an embodiment, the first feature object may be a feature object for representing a carriage. For example, a ratio of a number of first feature objects to the number of carriages is less than or equal to 2, that is, the first feature objects hardly recur in the carriages. For example, the first feature object is a carriage door, a toilet, or the like. A ratio of a number of second feature objects to the number of carriages is greater than 2, that is, the second feature objects recur in the carriages. For example, the second feature objects are a seat, a window, and the like.

Although the carriage where the robot is located may be determined according to the number of second feature objects by which the robot has passed, a large amount of calculation is required for determining the carriage where the robot is located according to the number of second feature objects. For example, based on the embodiment shown in FIG. 1, in order to reach the required position of the seat in row 6 in carriage 4, a recorded number of seats by which the robot has passed is 65.

According to this embodiment, the carriage where the robot is located may be first determined according to the number of first feature objects by which the robot has passed, and then second feature objects corresponding to the robot in the carriage where the robot is located are determined according to the number of second feature objects by which the robot has passed in the carriage where the robot is located. For example, if the robot needs to reach the seat in row 6 in carriage 4, a number of carriage doors by which the robot has passed by may be recorded first, that is, only 6 carriage doors (each carriage includes 2 carriage doors) need to be recorded to determine that the robot is located in carriage 4. Then a number of seats by which the robot has passed in carriage 4 is recorded, and only 5 rows of seats need to be recorded to determine that the robot reaches the position corresponding to the seat in row 6 in carriage 4.

Compared with recording of 65 rows of seats, the number of 6 carriage doors and 5 rows of seats that are recorded is smaller, which helps reduce a computational burden of the robot.

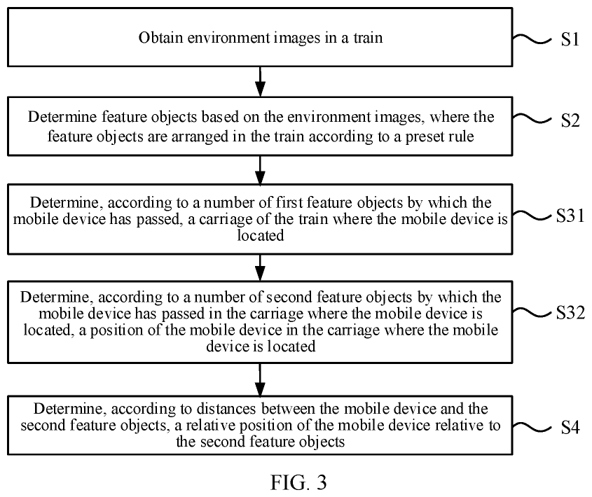

FIG. 3 is a schematic flowchart of another in-train localization method according to an embodiment of this application. As shown in FIG. 3, based on the embodiment shown in FIG. 2, the method further includes the following step.

Step S4: Determine a relative position of the mobile device and the second feature objects according to distances between the mobile device and the second feature objects.

Only the position of the robot in the train can be determined according to the number of feature objects by which the robot has passed, and there is a relatively large error in the position. For example, the feature object is still a seat, and a distance between two rows of seats is 1 meter. When the robot has passed by an n^{th} row of seats but has not passed by an (n+1)^{th} row of seats, it can only be determined that the position is in a region between the n^{th} row of seats and the (n+1)^{th} row of seats. Therefore, the error in the determined position of the robot is about 1 meter.

By further determining the distances between the robot and the second feature objects, the relative positions of the mobile device and the second feature objects may be determined. For example, the obtained environment image is a depth image. According to a depth of the seat in the environment image, the distance from the seat to the robot may be determined, that is, a relative distance between the robot and the seat in a length direction of the train. An error in the relative distance between the robot and the seat is much smaller than the distance between the two rows of seats. For example, when the robot has passed by the n^{th} row of seats, but has not passed by the (n+1)^{th} row of seats, relative distances between the robot and the (n+1)^{th} row of seats may be determined. For example, if the relative distance is 0.4 meters, it may be determined that the robot is currently located between the n^{th} row of seats and the (n+1)^{th} row of seats and at a distance of 0.4 meters from the (n+1)^{th} row of seats. This is more accurate than only determining that the position is in the region between the n^{th} row of seats and the (n+1)^{th} row of seats, which facilitates more accurate localization of the robot.

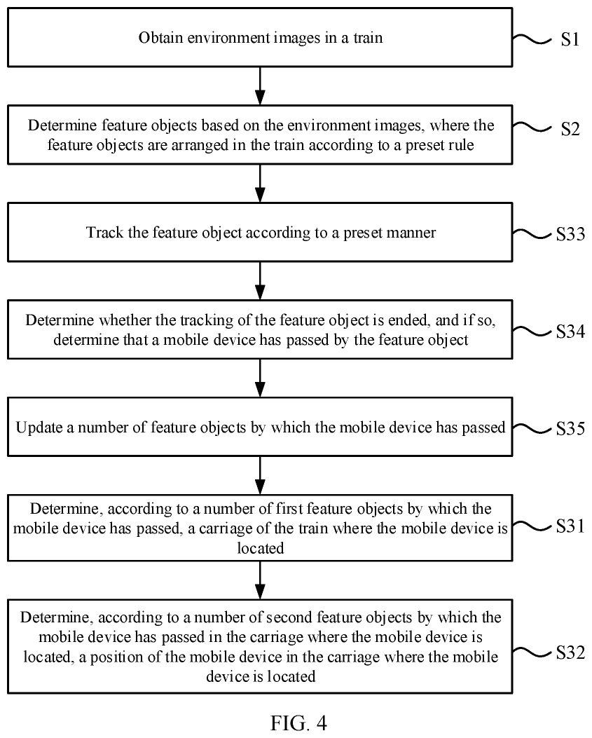

FIG. 4 is a schematic flowchart of determining a number of feature objects by which a mobile device has passed according to an embodiment of this application. As shown in FIG. 4, based on the embodiment shown in FIG. 2, the number of feature objects by which the robot has passed is determined in a manner including the following steps.

Step S33: Track the feature object according to a preset manner.

Step S34: Determine whether the tracking of the feature object is ended, and if so, determine that the mobile device has passed by the feature object.

Step S35: Update the number of feature objects by which the mobile device has passed.

In an embodiment, after the feature object in the environment image is determined, the feature object may be tracked in the preset manner. The preset manner may be selected according to requirements, and the following embodiments mainly focus on two preset manners for exemplified description.

For example, one is to end the tracking of the feature object when the feature object in the environment image meets a specific condition, and the other is to end the tracking of the feature object when the feature object is not present in the environment image (for example, disappears from a current frame of the environment image).

After tracking of one feature object is ended each time, it may be determined that the robot has passed by one feature object, and the number of feature objects may be updated. For example, each time the robot passes by one feature object, 1 is added to a currently recorded number of feature objects. By analogy, the number of feature objects by which the robot has passed may be determined, and the position of the robot can be determined based on the number.

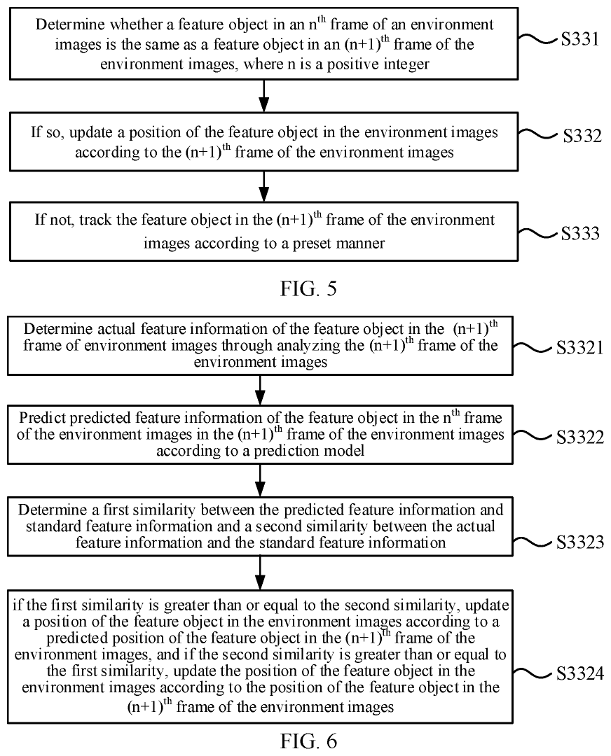

FIG. 5 is a schematic flowchart of tracking a feature object according to a preset manner according to an embodiment of this application. As shown in FIG. 5, based on the embodiment shown in FIG. 4, the tracking the feature objects according to a preset manner includes the following steps.

Step S331: Determine whether a feature object in an n^{th} frame of the environment images is the same feature object as a feature object in an (n+1)^{th} frame of the environment images, where n is a positive integer.

Step S332: If so, update a position of the feature object in the environment images based on the (n+1)^{th} frame of the environment images.

Step S333: If not, track the feature object in the (n+1)^{th} frame of the environment images according to the preset manner.

In an embodiment, a plurality of frames of the environment image may be consecutively collected. When the (n+1)^{th} frame of the environment image is collected, feature objects in the (n+1)^{th} frame of the environment image may be determined, and the feature objects in the (n+1)^{th} frame of the environment image may be compared with the feature objects in the n^{th} frame of the environment image, for example, bounding boxes of the feature objects are compared. The comparison may be performed based on normalization cross correlation (NCC), and a position of the feature object (for example, a position of a center of the bounding box) and a movement speed of the robot may also be considered during the comparison. For example, a time at which the n^{th} frame of the environment image is collected and a time at which the (n+1)^{th} frame of the environment image is collected differ by 0.1 seconds, the movement speed of the robot is 0.5 m/s, and positions of the feature object in the n^{th} frame of the environment image and the feature object in the (n+1)^{th} frame of the environment image relative to the robot differ by 1 meter, which is much greater than 0.05 meters. In this case, it may be determined that the feature object in the (n+1)^{th} frame of the environment image and the feature object in the n^{th} frame of the environment image are different feature objects. In other words, if the feature object in the (n+1)^{th} frame of the environment image is the same feature object as the feature object in the n^{th} frame of the environment image, the relative positions of the two feature objects relative to the robot differ by about 0.05 meters.

In addition to the above manner, other manners may also be selected as required for comparison. A specific comparison process is not a main improvement of this embodiment, and therefore details are not described herein again.

If it is determined, according to the comparison result, that the feature object in the (n+1)^{th} frame of the environment image is the same feature object as the feature object in the n^{th} frame of the environment image, that is, the feature object appeared in both of the n^{th} frame of the environment image and the (n+1)^{th} frame of the environment image, the position of the feature object in the environment image may be updated according to the position of the feature object in the (n+1)^{th} frame of the environment image. In this way, it can be ensured that the stored position of the feature object corresponds to the recently collected environmental image, so as to accurately determine a region where the feature object is located in each frame of the environment image, thereby determining the frame of the environment image in which the mobile device passed by the feature object.

If it is determined, according to the comparison result, that the feature object in the (n+1)^{th} frame of the environment image and the feature object in the n^{th} frame of the environment image are not the same feature object, that is, the feature object does not appear in the n^{th} frame of the environment image but appears in the (n+1)^{th} frame of the environment image, it indicates that the feature object is a new feature object appearing in the (n+1)^{th} frame of the environment image. Therefore, the new feature object may be tracked, and a tracking manner is the same as that of the above feature object. Details are not described herein again.

FIG. 6 is a schematic flowchart of updating a position of a feature object in an environment image according to an embodiment of this application. As shown in FIG. 6, based on the embodiment shown in FIG. 5, the updating a position of the feature object in the environment image based on the (n+1)^{th} frame of the environment image includes the following steps.

Step S3321: Determine actual feature information of the feature object in the (n+1)^{th} frame of the environment images through analyzing the (n+1)^{th} frame of the environment images.

Step S3322: Predict predicted feature information of the feature object in the n^{th} frame of the environment images in the (n+1)^{th} frame of the environment images according to a prediction model.

Step S3323: Determine a first similarity between the predicted feature information and standard feature information and a second similarity between the actual feature information and the standard feature information.

Step S3324: If the first similarity is greater than or equal to the second similarity, update the position of the feature object in the environment images according to a predicted position of the feature object in the (n+1)^{th} frame of the environment images; and if the second similarity is greater than or equal to the first similarity, update the position of the feature object in the environment images according to a position of the feature object in the (n+1)^{th} frame of the environment images.

In an embodiment, when the (n+1)^{th} frame of the environment image is collected, the (n+1)^{th} frame of the environment image may be analyzed, so as to determine the actual feature information of the feature object in the (n+1)^{th} frame of the environment image.

In addition, a first prediction model may be pre-trained through machine learning. The first prediction model can predict feature information of a feature object in a frame of the environment image when appearing in a next frame of the environment image. Therefore, when the (n+1)^{th} frame of the environment image is collected, predicted feature information of the feature object in the n^{th} frame of the environment image in the (n+1)^{th} frame of the environment image may be predicted according to the first prediction model (for example, prediction is performed by using feature information of feature objects in first n frames of the environment image as an input).

Types of the feature information included in the predicted feature information and actual feature information may be the same, for example, including but not limited to a shape, a color, and relative positions of other feature objects.

The environment in the train is not changeless and may change in some cases. For example, when the n^{th} frame of the environment image is collected, the feature object in the image is not shielded, and when the (n+1)^{th} frame of the environment image is collected, passengers stand up and shield the feature object. As a result, actual feature information of the feature object determined through analyzing the (n+1)^{th} frame of the environment image is different from standard feature information of the feature object, that is, differs greatly from feature information of the feature object in the n^{th} frame of the environment image. In this case, if it is determined, based on the actual feature information, frame of the environment image whether the feature object in the (n+1)^{th} frame of the environment image is the same feature object as the feature object in the n^{th} frame of the environment image an erroneous determining result may be obtained.

The standard feature information is pre-stored feature information about feature objects. For example, the feature object is a seat in the train. In this case, before the robot obtains an environment image in the train, a shape, a color, and a position of the seat may be collected as standard feature information and stored in a memory of the robot. The pre-stored standard feature information can reflect true feature information of the feature object for subsequent comparison with the actual feature information.

However, the predicted feature information of the feature object in the n^{th} frame of the environment image in the (n+1)^{th} frame of the environment image is predicted according to the first prediction model without analyzing the (n+1)^{th} frame of the environment image, so that the above erroneous determination can be avoided.

Further, since the predicted result may also be erroneous, in order to ensure that the position of the feature object in the environment image is accurately updated, the first similarity between the predicted feature information and the standard feature information and the second similarity between the actual feature information and the standard feature information may be determined and compared. The standard feature information may be obtained by measuring the feature objects and stored in the robot.

If the first similarity is greater than the second similarity, it indicates that predicted prediction position information of the feature object in the (n+1)^{th} frame of the environment image is more consistent with standard feature information of the feature object, so that the position of the feature object in the environment image may be updated according to a predicted position of the feature object in the (n+1)^{th} frame of the environment image.

A second prediction model may be pre-trained through machine learning. The second prediction model can predict a position of a feature object in a frame of the environment image when appearing in a next frame of the environment image, that is, predict position information. Therefore, when the (n+1)^{th} frame of the environment image is collected, predicted position information of the feature object in the n^{th} frame of the environment image in the (n+1)^{th} frame of the environment image may be predicted according to the second prediction model (for example, prediction is performed by using position information of feature objects in first n frames of the environment image as an input).

If the second similarity is greater than the first similarity, it indicates that actual feature information of the feature object determined through analyzing the (n+1)^{th} frame of the environment image is more consistent with the standard feature information of the feature object, so that the position of the feature object in the environment image may be updated according to an actual position of the feature object that is determined through analyzing the (n+1)^{th} frame of the environment image.

The first similarity being equal to the second similarity may be equivalent to the first similarity being greater than the second similarity, or may be equivalent to the second similarity being greater than the first similarity.

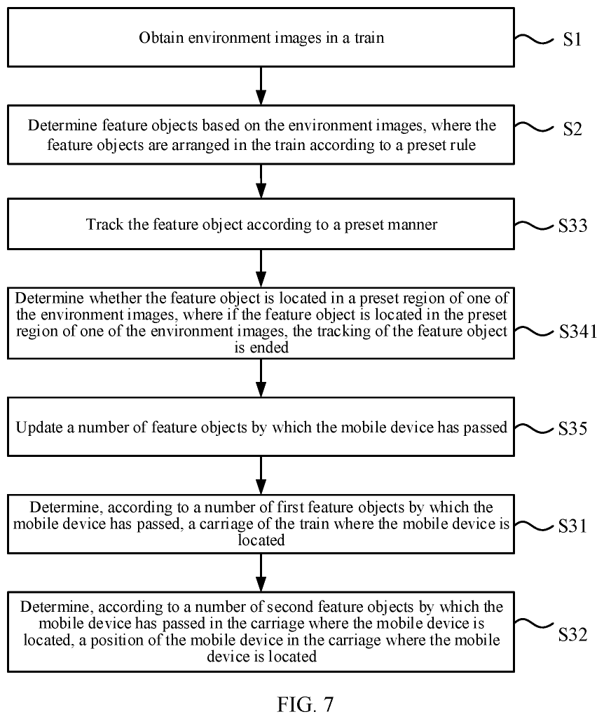

FIG. 7 is a schematic flowchart of determining whether tracking of a feature object is ended according to an embodiment of this application. As shown in FIG. 7, based on the embodiment shown in FIG. 4, the determining whether the tracking of the feature objects is ended includes the following step.

Step S341: Determine whether the feature object is located in a preset region of one of the environment images, where if the feature object is located in the preset region of one of the environment images, the tracking of the feature object is ended.

In an embodiment, as the robot moves, a position where the robot collects an environment image changes, resulting in a change of a region where the feature object is located in the collected environment image. For example, the image collecting device is located on the robot. In this case, when the robot moves forward, the feature object moves backward relative to the robot. This movement relationship is embodied in a plurality of frames of the environment image. A feature object generally moves from a middle part of the environment image to a lower left part or a lower right part of the environment image. When the robot passes by a feature object, the image collecting device cannot collect the feature object, that is, the feature object disappears from the environment image. Therefore, when the feature object is located in the preset region in the environment image, for example, when the feature object is located at a lower left corner or a lower right corner of the environment image, it may be determined that the feature object is to disappear from the environment image, that is, the robot is to pass the feature, so that the tracking of the feature object can be ended, and it is determined that the robot has passed by the feature object.

The preset region may be arranged according to requirements, for example, arranged at a lower left corner, a lower right corner, or the like of the environment image. A manner of determining whether the feature objects are located in the preset region of the environment image may be selected according to requirements. Two implementations are mainly described below.

In a first manner, the positions of the feature objects in the environment image may be determined first, and then distances between the positions and a center of the environment image, and an included angle between connecting lines that connect the position to the center of the environment image and a horizontal line and a vertical line that are in the same plane as the connecting line are determined, and a coordinate system is established by using the center of the environment image as an origin. Coordinates of the feature object in the coordinate system are determined according to the distances and the included angle, and then it may be determined, based on the coordinates, whether the feature object is located in the preset region of the environment image.

In a second manner, determining may be performed through deep learning. For example, after a feature object in a frame of the environment image is determined, feature information such as an area, a color, a shape, and the like of the feature object in the environment image may be further determined, and then the feature information is processed based on a deep learning algorithm to obtain a position of the feature object in the environment image, that is, a position of the feature object in the environment image relative to a center of the environment image, thereby determining whether the feature object is located in a preset region of the environment image according to whether the relative position is located in the preset region.

Optionally, the feature objects are second feature objects. For example, a ratio of a number of second feature objects such as a number of seats in a train to a number of carriages is greater than 2.

In an embodiment, the embodiment in FIG. 5 may be applied to the second feature objects whose number to the number of carriages is greater than 2. Such second feature objects recur in the carriages, such as seats, windows, and the like. The windows are exemplified. During the movement of the robot, the robot is to frequently pass by the windows which include new windows, which leads to a plurality of windows likely to appear in the same environment image. However, simultaneous tracking of a plurality of feature objects increases a data processing burden on the robot. Therefore, for such second feature objects, when the second feature objects are located in the preset region in the environment image, the tracking may be determined to be ended. For example, if there are 5 windows in the same environment image, the 5 windows need to be tracked. When one of the windows is located in the preset region of the environment image, although the window is still in the environment image, the tracking of the window can be ended. In this way, before a new window enters the environment image, only 4 windows need to be tracked, facilitating reduction of the data processing burden on the robot.

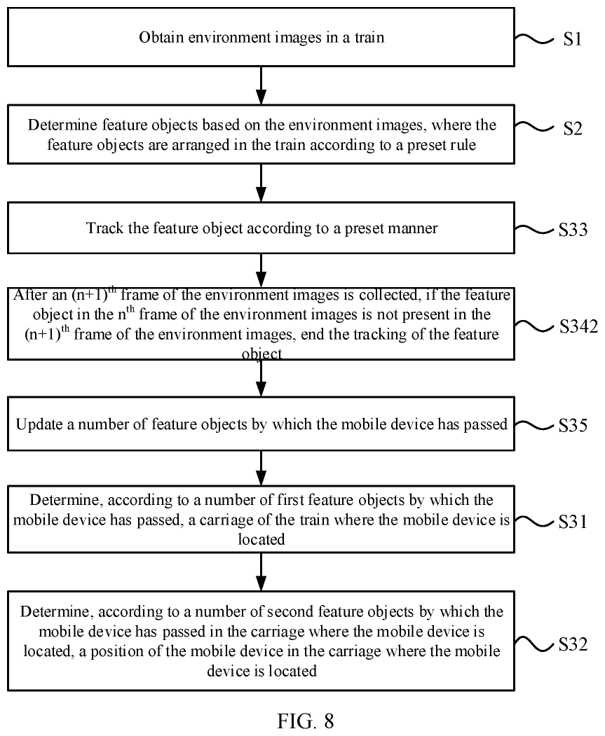

FIG. 8 is a schematic flowchart of another method of determining whether tracking of a feature object is ended according to an embodiment of this application. As shown in FIG. 8, based on the embodiment shown in FIG. 4, the determining whether the tracking of the feature objects is ended includes the following step.

Step S342: When the (n+1)^{th} frame of the environment images is collected, if the feature object in the n^{th} frame of the environment images is not present in the (n+1)^{th} frame of the environment images, end the tracking of the feature object.

In an embodiment, it may be determined whether the feature object in the n^{th} frame of the environment image is present the (n+1)^{th} frame of the environment image. For example, bounding boxes of all feature objects that are obtained from the (n+1)^{th} frame of the environment image differ greatly from bounding boxes of the feature objects in the n^{th} frame of the environment image. In this case, it may be determined that the feature object in the n^{th} frame of the environment image is not present in the (n+1)^{th} frame of the environment image, thus ending the tracking of the feature object.

Optionally, the feature objects are first feature objects. For example, a ratio of a number of first feature objects in the train to a number of carriages is less than or equal to 2.

In an embodiment, the embodiment in FIG. 6 may be applied to the first feature objects whose number to the number of carriages is less than or equal to 2. Such first feature objects appear at most 2 times in the carriage, such as a carriage door, a toilet, and the like. The carriage door is exemplified. During the movement of the robot, the robot passes by only 2 carriage doors when passing through a carriage each time. Compared with the second feature objects such as seats and windows, 2 or more carriage doors generally do not appear in the same environment image. Therefore, for such first feature objects, when the first feature objects are present in the n^{th} frame of the image but do not exist in the (n+1)^{th} frame of the image, tracking of the first feature objects may be determined to be ended when the (n+1)^{th} frame of the image is collected. Compared with the embodiment shown in FIG. 5, the method is relatively simple, facilitating reduction of the data processing burden on the robot.

Corresponding to the above embodiment of the in-train localization method, this application further provides an embodiment of an in-train localization apparatus.

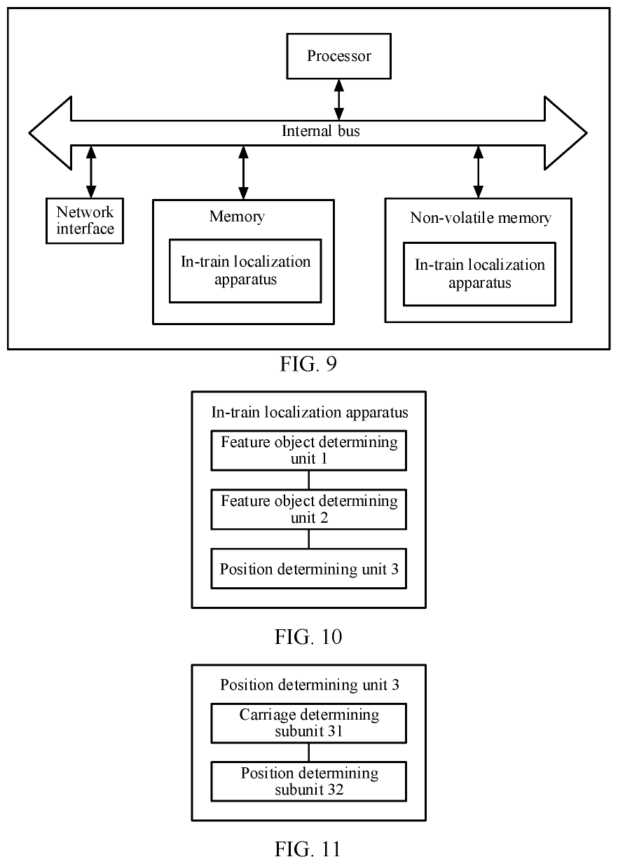

The embodiment of the in-train localization apparatus in this application may be applied to a robot. The device embodiments may be implemented by using software, or hardware or in a manner of a combination of software and hardware. Using a software implementation as an example, as a logical apparatus, the apparatus is formed by reading corresponding computer program instructions from a non-volatile memory into an internal memory by a processor of an electronic device where the apparatus is located. In terms of hardware, FIG. 9 is a hardware structure diagram of a robot where the above in-train localization apparatus is located according to the embodiment of this application. In addition to a processor, a memory, a network interface, and a non-volatile memory shown in FIG. 9, the robot where the apparatus is located in the embodiment usually may further include other hardware according to an actual function of the robot, and details are not described again.

FIG. 10 is a schematic block diagram of an in-train localization apparatus according to an embodiment of this application. The apparatus in this embodiment is applicable to a mobile device such as a robot. The robot can move in a train, and can perform tasks such as delivery (for example, a cargo loading apparatus is equipped on the robot), ticket inspection (for example, a scanning apparatus is equipped on the robot), and cleaning (for example, a cleaning apparatus is equipped on the robot).

As shown in FIG. 10, the in-train localization apparatus may include:

an image obtaining unit 1 configured to obtain an environment image in a train;

a feature object determining unit 2 configured to determine feature objects based on the environment image, where the feature objects are arranged in the train according to a preset rule; and

a position determining unit 3 configured to determine, based on a number of feature objects by which the mobile device has passed, a position of a mobile device in the train.

FIG. 11 is a schematic block diagram of a position determining unit according to an embodiment of this application. As shown in FIG. 11, based on the embodiment shown in FIG. 10, the feature objects include first feature objects and second feature objects, and the position determining unit 3 includes:

a carriage determining subunit 31 configured to determine, according to a number of first feature objects by which the mobile device has passed, a carriage in the train where the mobile device is located; and

a position determining subunit 32 configured to determine, according to a number of second feature objects by which the mobile device has passed in the carriage where the mobile device is located, a position of the mobile device in the carriage where the mobile device is located.

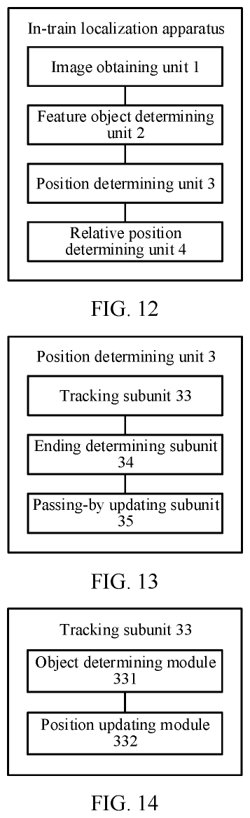

FIG. 12 is a schematic block diagram of another in-train localization apparatus according to an embodiment of this application. As shown in FIG. 12, based on the embodiment shown in FIG. 11, the apparatus further includes:

a relative position determining unit 4 configured to determine relative positions of the mobile device and the second feature objects according to distances between the mobile device and the second feature objects.

FIG. 13 is a schematic block diagram of another position determining unit according to an embodiment of this application. As shown in FIG. 13, based on the embodiment shown in FIG. 11, the position determining unit 3 includes:

a tracking subunit 33 configured to track the feature objects according to a preset manner;

an ending determining subunit 34 configured to determine whether the tracking of the feature objects is ended, and if so, determine that the mobile device has passed by the feature objects; and

a passing-by updating subunit 35 configured to update the number of feature objects by which the mobile device has passed.

FIG. 14 is a schematic block diagram of a tracking subunit according to an embodiment of this application. As shown in FIG. 14, based on the embodiment shown in FIG. 13, the tracking subunit 33 includes:

an object determining module 331 configured to determine whether a feature object in an n^{th} frame of an environment image is the same feature object as a feature object in an (n+1)^{th} frame of the environment image, where n is a positive integer;

a position updating module 332 configured to: if so, update a position of the feature object in the environment image based on the (n+1)^{th} frame of the environment image.

If not, the tracking subunit 33 tracks the feature object in the (n+1)^{th} frame of the environment image according to the preset manner.

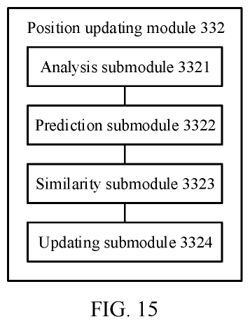

FIG. 15 is a schematic block diagram of a position updating module according to an embodiment of this application. As shown in FIG. 15, based on the embodiment shown in FIG. 14, the position updating module 332 includes:

an analysis submodule 3321 configured to determine actual feature information of the feature object in the (n+1)^{th} frame of the environment image through analyzing the (n+1)^{th} frame of the environment image;

a prediction submodule 3322 configured to predict predicted feature information of the feature object in the n^{th} frame of the environment image in the (n+1)^{th} frame of the environment image according to a prediction model;

a similarity submodule 3323 configured to determine a first similarity between the predicted feature information and standard feature information and a second similarity between the actual feature information and the standard feature information; and

an updating submodule 3324 configured to: if the first similarity is greater than or equal to the second similarity, update the position of the feature object in the environment image according to a predicted position of the feature object in the (n+1)^{th} frame of the environment image; and if the second similarity is greater than or equal to the first similarity, update the position of the feature object in the environment image according to the position of the feature object in the (n+1)^{th} frame of the environment image.

Optionally, the ending determining subunit is configured to determine whether the second feature objects are located in a preset region of the environment image, where if the second feature objects are located in the preset region of the environment image, the tracking of the second feature objects is ended.

Optionally, the ending determining subunit is configured to: when the (n+1)^{th} frame of the environment image is collected, if the feature object in the n^{th} frame of the environment image is not present in the (n+1)^{th} frame of the environment image, end the tracking of the feature objects.

Reference to the implementation processes of corresponding steps in the foregoing method may be made for details of the implementation processes of the functions and effects of the units and the modules in the device. Details are not described herein again.

Because the apparatus embodiments basically correspond to the method embodiments, for related parts, reference may be made to the descriptions in the method embodiments. The foregoing described device embodiments are merely examples. The units described as separate parts may or may not be physically separate, and the parts displayed as units may or may not be physical units, may be located in one position, or may be distributed on a plurality of network units. Some or all of the units may be selected according to actual needs to achieve the objectives of the solutions of the embodiments of this application. A person of ordinary skill in the art may understand and implement the embodiments without creative efforts.

An embodiment of this application further provides an electronic device, including:

a processor; and

a memory configured to store instructions executable by the processor; where

the processor is configured to perform the method according to any of the above embodiments. The electronic device may be a robot, a terminal of a controller of a driving device, or a server.

An embodiment of this application further provides a computer readable storage medium having stored thereon a computer program which, when executed by a processor, performs the steps in the method according to any of the above embodiments.

1. An in-train localization method, comprising:
obtaining environment images in a train;
determining feature objects based on the environment images, wherein the feature objects are arranged in the train according to a preset rule; and
determining a position of a mobile device in the train based on a number of feature objects by which the mobile device has passed.

2. The method according to claim 1, wherein the feature objects comprise first feature objects and second feature objects, and determining the position of the mobile device in the train based on the number of feature objects by which the mobile device has passed comprises:
determining, according to a number of first feature objects by which the mobile device has passed, a carriage of the train where the mobile device is located; and
determining, according to a number of second feature objects by which the mobile device has passed in the carriage where the mobile device is located, a position of the mobile device in the carriage where the mobile device is located.

3. The method according to claim 1, wherein the number of feature objects by which the mobile device has passed is determined by:
for each feature object of the feature objects,
tracking the feature object according to a preset manner;
determining whether the tracking of the feature object is ended, and if the tracking of the feature object is ended, determining that the mobile device has passed by the feature object; and
updating the number of feature objects by which the mobile device has passed.

4. The method according to claim 3, wherein tracking the feature object according to the preset manner comprises:
determining whether the feature object in an n^{th} frame of the environment images is the same feature object as the feature object in an (n+1)^{th} frame of the environment images, wherein n is a positive integer;
if the feature object in the n^{th} frame of the environment images is the same feature object as the feature object in the (n+1)^{th} frame of the environment images, updating a position of the feature object in the environment images based on the (n+1)^{th} frame of the environment images; and
if the feature object in the n^{th} frame of the environment images is not the same feature object as the feature object in the (n+1)^{th} frame of the environment images, tracking the feature object in the (n+1)^{th} frame of the environment images according to the preset manner.

5. The method according to claim 4, wherein updating the position of the feature object in the environment images based on the (n+1)^{th} frame of the environment images comprises:
determining actual feature information of the feature object in the (n+1)^{th} frame of the environment images through analyzing the (n+1)^{th} frame of the environment images;
predicting predicted feature information of the feature object in the n^{th} frame of the environment images in the (n+1)^{th} frame of the environment images according to a prediction model;
determining a first similarity between the predicted feature information and standard feature information and a second similarity between the actual feature information and the standard feature information; and
if the first similarity is greater than or equal to the second similarity, updating the position of the feature object in the environment images according to a predicted position of the feature object in the (n+1)^{th} frame of the environment images, and if the second similarity is greater than or equal to the first similarity, updating the position of the feature object in the environment images according to a position of the feature object in the (n+1)^{th} frame of the environment images.

6. The method according to claim 3, wherein determining whether the tracking of the feature object is ended comprises:
determining whether the feature object is located in a preset region of one of the environment images, and
if the feature object is located in the preset region of one of the environment images, the tracking of the feature object is ended.

7. The method according to claim 6, wherein determining whether the feature object is located in the preset region of one of the environment images comprises:
determining a position of the feature object in one environment image;
determining a distance between the feature object and a center of the environment image, and determining an included angle between a connecting line, which connects the position of the feature object in the environment image to the center of the environment image, and a horizontal line, wherein the horizontal line and the connecting line are in the same plane;
establishing a coordinate system with the center of the environment image as an origin, and determining a coordinate of the feature object in the coordinate system according to the distance and the included angle; and
determining, according to the coordinate, whether the feature object is located in the preset region of the environment image.

8. The method according to claim 6, wherein determining whether the feature object is located in the preset region of one of the environment images comprises:
determining the feature object in one environment image;
determining feature information of the feature object in the environment image;
obtaining, according to the feature information, a relative position of the feature object in the environment image relative to a center of the environment image; and
determining, according to the relative position of the feature object in the environment image, whether the feature object is located in the preset region of the environment image.

9-10. (canceled)

11. An in-room localization method, comprising:
obtaining environment images in a room;
determining feature objects based on the environment images, wherein the feature objects are arranged in the room according to a preset rule; and
determining a position of a mobile device in the room based on a number of feature objects by which the mobile device has passed.

12. The method according to claim 11, wherein the feature objects comprise first feature objects and second feature objects, and determining the position of the mobile device in the room based on the number of feature objects by which the mobile device has passed comprises:
determining, according to a number of first feature objects by which the mobile device has passed, a first position of the mobile device in the room that is related to the first feature objects; and
determining, according to a number of second feature objects by which the mobile device has passed at the first position, a second position of the mobile device in the room that is related to the second feature objects.

13. The method according to claim 11, wherein the number of feature objects by which the mobile device has passed is determined by:
for each feature object of the feature objects,
tracking the feature object according to a preset manner;
determining whether the tracking of the feature object is ended, and if the tracking of the feature object is ended, determining that the mobile device has passed by the feature object; and
updating the number of feature objects by which the mobile device has passed.

14. The method according to claim 13, wherein tracking the feature object according to the preset manner comprises:
determining whether the feature object in an n^{th} frame of the environment images is the same feature object as the feature object in an (n+1)^{th} frame of the environment images, wherein n is a positive integer;
if the feature object in the n^{th} frame of the environment images is the same feature object as the feature object in the (n+1)^{th} frame of the environment images, updating a position of the feature object in the environment images based on the (n+1)^{th} frame of the environment images; and
if the feature object in the n^{th} frame of the environment images is not the same feature object as the feature object in the (n+1)^{th} frame of the environment images, tracking the feature object in the (n+1)^{th} frame of the environment images according to the preset manner.

15. The method according to claim 14, wherein updating the position of the feature object in the environment images based on the (n+1)^{th} frame of the environment images comprises:
determining actual feature information of the feature object in the (n+1)^{th} frame of the environment images through analyzing the (n+1)^{th} frame of the environment images;
predicting predicted feature information of the feature object in the n^{th} frame of the environment images in the (n+1)^{th} frame of the environment images according to a prediction model;
determining a first similarity between the predicted feature information and standard feature information and a second similarity between the actual feature information and the standard feature information; and
if the first similarity is greater than or equal to the second similarity, updating the position of the feature object in the environment images according to a predicted position of the feature object in the (n+1)^{th} frame of the environment images, and if the second similarity is greater than or equal to the first similarity, updating the position of the feature object in the environment images according to a position of the feature object in the (n+1)^{th} frame of the environment images.

16. The method according to claim 13, wherein determining whether the tracking of the feature object is ended comprises:
determining whether the feature object is located in a preset region of one of the environment images, and
if the feature object is located in the preset region of one of the environment images, the tracking of the feature object is ended.

17. The method according to claim 16, wherein determining whether the feature object is located in the preset region of one of the environment images comprises:
determining a position of the feature object in one environment image;
determining a distance between the feature object and a center of the environment image and determining an included angle between a connecting line , which connects the position of the feature object in the environment image to the center of the environment image, and a horizontal line, wherein the horizontal line and the connecting line are in the same plane;
establishing a coordinate system with the center of the environment image as an origin, and determining a coordinate of the feature object in the coordinate system according to the distance and the included angle; and
determining, according to the coordinate, whether the feature object is located in the preset region of the environment image.

18. The method according to claim 16, wherein determining whether the feature object is located in the preset region of one of the environment images comprises:
determining the feature object in one environment image;
determining feature information of the feature object in the environment image;
obtaining, according to the feature information, a relative position of the feature object in the environment image relative to a center of the environment image; and
determining, according to the relative position of the feature object in the environment image, whether the feature object is located in the preset region of the environment image.

19-20. (canceled)

21. A mobile device, comprising:
a processor; and
a memory configured to store instructions executable by the processor; wherein
the processor is configured to perform the method according to claim 1.

22. A mobile device, comprising:
a processor; and
a memory configured to store instructions executable by the processor; wherein
the processor is configured to perform the method according to claim 11.

23. A computer readable storage medium having stored thereon a computer program which, when executed by a processor, performs the method according to claim 1.

24. A computer readable storage medium having stored thereon a computer program which, when executed by a processor, performs the method according to claim 11.
